(19) United States
(12) Patent Application Publication
(10) Pub. No.: US 2019/0041134 A1
(43) Pub. Date: Feb. 7, 2019

(54) CONTINUOUS FLOW DRYER HAVING AT LEAST TWO SECTIONS

(71) Applicant: STELA Laxhuber GmbH, Massing (DE)

(72) Inventors: Thomas Christian Laxhuber, Massing (DE); Tobias Latein, Erlbach (DE)

(73) Assignee: STELA Laxhuber GmbH, Massing (DE)

(21) Appl. No.: 16/073,082

(22) PCT Filed: Feb. 1, 2017
(86) PCT No.: PCT/DE2017/100064

§ 371 Date: Jul. 26, 2018

(30) Foreign Application Priority Data
Feb. 1, 2016 (DE) 10 2016 101 725.6
Mar. 1, 2016 (DE) 10 2016 103 685.4

(51) Int. Cl. F26B 23/00; F26B 3/04; F26B 17/04; F26B 21/04

(52) U.S. Cl. CPC F26B 23/002; F26B 21/04; F26B 17/04; F26B 3/04

(57) ABSTRACT

The invention relates to a continuous flow dryer (10) for drying a material (14) by means of hot air (24), comprising a first and a second section (20, 22), which in a transport direction (18) are successively passed through by the material (14), and which in terms of flow are separated to a great extent. The invention is characterized in that a fresh air supply device (28) for supplying fresh air (26) as first infeed air (32) into the first section (20) is provided, an exhaust air recirculation device (44) for removing exhaust air (40) from the second section (22) and for recirculating exhaust air (40) as second infeed air (42) back into the second section (22) is provided. Furthermore, a heat exchanger (58) is provided, through which the fresh air (26) on the one hand and the exhaust air (40) on the other hand are guided, for transferring waste heat (62) of the exhaust air (40) into the fresh air (26).

### TECHNICAL FIELD

The invention relates to a continuous flow dryer for drying a material by means of hot air in at least two sections which are successively passed through by the material and largely separated in terms of air flow. The invention relates further to a continuous flow dryer for drying a material by means of hot air with a first and a second section through which are passed largely by the material in a transport direction, in which an air supply device for supplying fresh air to the second section is provided, and an exhaust air recirculation device for removing exhaust air from the first section.

### BACKGROUND

A continuous flow dryer is a dryer in which material to be dried is transported through the dryer continuously or in batches. Such a dryer is in particular a belt dryer which conveys the material to be dried through the continuous flow dryer. The material to be dried, for example, clarification sludge, wood chips, RDF (refuse-derived fuel), SSW (solid shredded waste), MSW (municipal solid waste), household waste, grass or agricultural products and by-products such as sugar beet pulp is in this case firstly moist or wet. The material is dried, during which moisture is removed by means of hot air. The hot air is specially produced by heating in particular air from the surroundings of the continuous flow dryer. On heating the air the relative humidity of this air falls, the air becomes “dryer”. This hot air with lower relative air moisture then flows through in the continuous flow dryer the material to be dried or flows around its constituents. The material to be dried is at the same time conveyed in a transport direction through the through-flow dryer and at the same time flows through at least two sections. The individual section subdivides the through-flow dryer spatially. The sections are largely separated from one another in terms of air flow.

Thus, in the sections, different air flows are possible, which each have different relative air moistures and different temperatures. For heating the air to hot air, energy is naturally required. This energy is lost when the hot air produced after the drying of the material is released into the surroundings after the drying of the material. First approaches are therefore known for recirculating the hot air.

In the through-flow dryer relevant here the heated air from the surroundings is supplied to the second section by means of an air supply device. This fresh air is cooled after flowing through the second section by taking up moisture from the material to be dried and is enriched with water and thus forms exhaust air. The exhaust air is nevertheless recirculated from the second section into the first section as supply air. This recirculated supply air then flows through the first section. On further flowing through, the material to be dried releases further moisture to this air. This air becomes further saturated and then is led out of the first section by means of an exhaust air device.

The sections are thus very largely separated such that in them different air flows are possible, which can each have different relative moisture and different temperature.

For heating the supply air as hot air, energy is of course required. This energy is lost when heated hot air is discharged into the surroundings of the through-flow dryer after drying the material. Therefore, as explained above, it is fundamentally desired to recirculate generated hot air as far as possible through many sections.

### SUMMARY

The object on which the invention is based is to create a through-flow dryer for drying a material by means of hot air which makes possible a further energy saving compared with known through-flow dryers.

This object is achieved according to the invention with a through-flow dryer for drying a material by means of hot air with a first and a second section, through which material is passed successively in a transport direction and largely separated in terms of air flow. Furthermore, a fresh air supply device is provided for supplying fresh air as first supply air into the first section, an exhaust air recirculating device is provided for discharging exhaust air from the second section and for recirculating exhaust air as second supply air back into the second section, and a heat exchanger is provided, through which on the one hand the fresh air and on the other hand the exhaust air are led for transmitting waste heat of the exhaust air into the fresh air.

In the through-flow dryer according to the invention, there is provided a fresh air supply device which supplies generally dry fresh air taken from the surroundings as first supply air to the through-flow dryer. At the through-flow dryer furthermore an exhaust air recirculating device leads exhaust air from a drying process out of the second section. This exhaust air is at least partly recirculated into the second section of the through-flow dryer. The exhaust air is in this case led according to the invention to a heat exchanger, at which thermal energy or waste heat is transferred from the exhaust air to the first supply air likewise flowing through the heat exchanger. The two flows of exhaust air and first air are in this case separated from one another at the heat exchanger in particular by means of a separating surface. At the separating surface, then on its one side the exhaust air flows along and on its other side the first supply air flows along. Through the separating surface, heat energy of the exhaust air is discharged to the fresh air. The waste heat of the exhaust air heats thus heats the fresh air supplied to the through-flow dryer and heat energy from the exhaust air is recovered. At the same time the air flows of exhaust air and first supply air are separated from one another in terms of moisture. The moisture contained in the exhaust air cannot therefore pass into the first supply air.

Advantageously the heat exchanger according to the invention is dimensioned such that moisture condenses out from the exhaust air on it. Moisture condenses out when the relative air moisture of the respectively relevant air has reached 100% (in words: one hundred per cent). The relative air moisture in air increases when the air, as in this case, cools. On the other hand, the relative air moisture decreases when the air is heated. These physical effects of the increase and decrease of the air moisture are shown in the Mollier-h,x diagram. The condensing out striven for according to the invention is preferably achieved by the fact that the separating surface of the heat exchanger is dimensioned such that moisture from the exhaust air condenses out on it. For this, the exhaust air discharges so much thermal energy to the separating surface that the relative moisture in the exhaust air 100% (in words: one hundred per cent) is achieved. The heat exchanger according to the invention thus has advantageously three functions. The first function is the dehumidifying of the exhaust air which flows through the heat exchanger. The second function is the heating of the supplied fresh air. The third function is the reducing of relative air moisture of the supplied fresh air, caused by the heating of this fresh air.

According to the invention, preferably furthermore a first heater is provided for heating the first supply air before it is supplied into the first section. A heater heats air by means of energy supply. The heater is, for example, a hot water heat exchanger, a steam heat exchanger, an electric heating device or a heat burner. On heating the air with the heater, this supply air decreases, as already mentioned above, the relative air moisture of this supply air. A low air moisture is advantageous, since the such supply air can then take up more water. Warmer supply air can thus take up colder supply air. This first supply air is, according to the invention, supplied to the first section. In this first section the moisture of the material to be dried is still at its greatest in terms of its conveying direction. Therefore, it is particular advantageous if the take-up capacity of water of the supplied air is high in this section.

Furthermore, advantageously a second heater is provided for heating the second supply air before it is recirculated into the second section. As already described, the relative air moisture of air decreases when it is heated. A second heater which heats the second supply air thus decreases likewise the relative moisture in this second supply air and increases the temperature of the second supply air. A low relative air moisture in the second supply air is in particular then of advantage when comparatively low residual moisture is to be removed from the material to be dried in the second section.

Preferably, the exhaust air supply device is furthermore provided with a recirculating line which serves for direct recirculating of exhaust air from the second section as circulating air back into the second section. The exhaust air recirculating device then leads exhaust air from the second section directly and without intermediate handling back into the second section. The directly recirculated exhaust air from the second section is mixed with the second supply air supplied there, which accordingly has the result that a mixture of treated supply air and untreated supply air flows into the second section. This mixture has a mixing temperature and a mixing air moisture. Thus, the supply air is colder and dryer and the exhaust air is warmer and more moist. Advantageously the air can be very cold and very dry because it is directly heated by the albeit also moist, but warm component of the recirculated exhaust air. Furthermore, with this direct recirculation a particularly simple control of the moisture and of the temperature of the air in the second section is possible.

According to the invention, preferably at least two regions or subsections are provided in the second section which are largely separated in terms of air flow and the exhaust air of the two regions is collected by the heat exchanger in a guided manner. The second section is in this way for its part further subdivided, in fact into at least a first and a second region. These regions are connected in series successively in the transport direction. The respective region generally has its own temperature and its own relative moisture of the air flow inside this region. Advantageously this temperature and the relative moisture is adapted to the prevailing moisture conditions of the material to be dried there in each case. Exhaust air to be led away from the respective regions is brought together and led jointly to the heat exchanger. Advantageously, with the collecting of the exhaust air an exhaust air mixture forms. The exhaust air mixture has a largely uniform, common relative air moisture and a mixing temperature. Particularly advantageously, in this case not only for each individual region does a separate heat exchanger have to be provided, but in particular a single heat exchanger for the entire exhaust air to be discharged from the plurality of regions is sufficient.

Advantageously, furthermore in at least one of the sections and/or regions an exhaust air second is provided, by means of which in the exhaust air its moisture is to be determined. Such an air sensor determines in particular the relative air moisture and/or the temperature of the air flowing to or around it. Advantageously, the relative air moisture of the exhaust air is thus to be determined by means of the exhaust air sensor. If the relative moisture of the exhaust air is known, it can be defined by means of a control whether this exhaust air is to be dehumidified or whether this air is to be supplied again directly to the respective section or the respective region.

Alternatively or additionally, furthermore there is provided a supply air sensor, by means of which moisture in the supply air is to be determined. The supply air sensor determines the relative air moisture of the on-flowing supply air. Advantageously it can thus be determined the relative air moisture with which the supply air flows into the respective section. Particularly advantageously, it can thus also be determined whether and by how many degrees Celsius the supply air is to be heated up additionally by a heater, in order to achieve a desired relative air moisture in the supply air.

In a preferred manner, furthermore for transporting the material through the through-flow dryer two belts are provided, which are assigned in particular to the first section and the second section. Such a two-part belt in a continuous flow dryer enables each of the two sections to have a belt of their own. Thus, the two sections can also be arranged spatially separated from one another, in particular one above the other.

According to the invention, preferably the transport direction is directed from the second section to the first section. Such a transport direction is thus not orientated from the first section to the second section, but vice versa. Such a transport direction in the “opposite direction” makes it possible to dry the material lastly with supplied fresh air. This is particularly advantageous when the material is to be dried lastly with particularly pure air. As a further advantage, in this transport direction the second heater is designed small for heating the second supply air. Particularly advantageously this heater can be omitted.

Furthermore, advantageously also a regulating device is provided, by means of which the moisture in the exhaust air is to be measured and an air guidance in the exhaust air recirculation device is to be regulated. A regulating device or control evaluates inputs of the regulating device and regulates or controls by means of logic of the regulating device its outputs. As inputs here serve electrical signals of sensors of various kinds, such as for example a temperature sensor or a moisture sensor. As outputs serve mostly switches or electrical signals, for example for controlling the heater. By means of the regulating device, the air guidance is advantageous, in particular by means ventilation, in the exhaust air recirculation device at the respectively prevailing relative moisture of the exhaust air.

A method according to the invention for operating a through-flow dryer for drying a material by means of hot air with a first and a second section which are passed through successively by material in a transporting direction and are largely separated in terms of air flow, is designed with the steps: supplying fresh air as first supply air into the first section, and discharging of exhaust air from the second section, and recirculating exhaust air from the second section, and recirculating exhaust air as second supply air back into the second section and transmitting exhaust heat of the exhaust air into the fresh air.

This object is further achieved according to the invention with a through-flow dryer for drying a material by means of hot air with a first and a second section, through which the material is passed in a transport direction and are largely separated, wherein an air supply device for supplying fresh air to the second section, an exhaust air recirculation device for supplying fresh air to the second section, an exhaust air recirculation device for recirculating exhaust air from the second section into the first section as supply air and an exhaust air discharging device for discharging waste air from the first section are provided. Furthermore, according to the invention the air supply device is designed with a heat exchanger, through which the fresh air and the exhaust air are guided from the first section.

In the through-flow dryer according to the invention, an air supply device is provided, which supplies fresh air taken from the surroundings to a heat exchanger. The heat exchanger has in this case flowing through on the one hand fresh air and on the other hand recirculated exhaust air of the through-flow dryer is conveyed through the heat exchanger before at least two sections. The exhaust air thus recirculated has a high moisture content. It cools down on the heat exchanger and the water contained therein flows out. By means of the heat exchanger according to the invention on the one hand the supply air is warmed up and on the other hand however the exhaust air is also at the same time dehumidified.

The two air flows according to the invention are in this case in particular at the heat exchanger separated from one another by means of a separating surface. At the separating surface, there then flows past on the one side the exhaust air and on the other side the fresh air. By means of the separating surface the heat exchanger transmits a thermal energy or heat from the exhaust air to the fresh air. Thermal energy is transmitted from the exhaust air to the fresh air. A “thermal recovery” takes place. The fresh air is heated by means of the waste heat of the exhaust air. Owing to the heating the relative air humidity of the fresh air decreases, the fresh air becomes “dryer”. The fresh air is at the same time separated in terms of moisture. The moisture or liquid in the exhaust air can therefore pass over to the fresh air.

According to the invention, preferably the air supply device is designed such that the exhaust air from the first section is led out of the first section from the through-flow dryer as outgoing air. From the through-flow dryer there is led at only one place fresh air into the through-flow dryer and only at one place is outgoing air is led out of the continuous flow dryer. The through-flow dryer can thus be advantageously equipped with only a single heat exchanger, through which both fresh air and also outgoing air of the through-flow dryer are led.

Advantageously, the air supply device according to the invention is designed with a first heater for heating the supply air before it is supplied to the first section. A heater heats by means of energy supply the air flowing through it. The heater is, for example, an electric heating device, a heat burner or a heat register through which flows heating fluid. On the heating of the air by means of the heater the relative air moisture falls. A low air moisture is advantageous on drying, since then in particular the fresh air heated in this manner can take up more moisture or water. The heated supply air is according to the invention of the second section, therefore supplied preferably with a section at the rear in the transporting direction or a section arranged further behind than the first section. In this second section the relative moisture of the material to be dried is, with respect to its conveying direction, comparatively low. Therefore it is particularly advantageous if the take-up capacity of water of the fresh air supplied in this section is particularly high.

According to the invention, preferably the exhaust air recirculating device is designed with a second heater which serves for heating the supply air before it is supplied to the second section. With the second heater preferred according to the invention, the supply air is further heated before the supply into the second section is further heated. Thus, it is possible in the second section to particularly highly reduce the relative moisture of the material dried there.

In a preferred manner furthermore a supply air sensor is provided, by means of which in the air downstream or before the heater its moisture can be determined. The supply air sensor determines the relative air moisture of the on-flowing supply air. Advantageously, it can thus be determined with which relative air moisture the supply air flows into the respective section. Particularly advantageously it can thus also be determined whether and by how many degrees Celsius the supply air can be heated additionally by means of a heater, in order to achieve a desired relative air moisture in the supply air.

According to the invention, preferably furthermore the exhaust air recirculation device is designed with a fan, for controlled recirculating of air through the exhaust air recirculation device. The fan sucks in particular air from the section associated with it and leads this air back to the following section. By means of the fan, it is in this case controlled how much air is sucked out of the respective section and preferably then is also led on to the following exhaust air recirculation device. Particularly preferably there is also provided a fan at or on the exhaust air recirculation device, since this brings about a particularly uniform distribution of the air conveyance through the respective sections.

In a preferred manner the first section is furthermore subdivided into at least two regions, each of which is assigned an exhaust air recirculation device for recirculating exhaust air from the upstream region into the respectively following downstream. The regions form in this case an air flow subdivision of the first section. This subdivision or separation has the effect that the individual regions for their part can have different temperatures and moistures. The regions thus form a kind of “series connection”, in which the exhaust air is recirculated from the preceding region into the respective following region. Particularly advantageously, a plurality of almost identical regions are thus coupled to one another. By means of this arrangement of a plurality of following regions, the through-flow dryer according to the invention is simply scalable with regard to its power and size.

Furthermore advantageously the transport direction of the transport belt is designed either directed from the first section to the second section or from the second section to the first section. A transport direction of the transport belt from the first section to the second section has the effect that moist or wet material is pre-dried from the first section by means of the exhaust air of the second section. Subsequently, the pre-dried material in the second section is post-dried by means of the supplied fresh air. This transporting direction is advantageous particularly when the material at the end of its transporting path is to be dried as much as possible. It is preferable however for the transport direction of the transport belt to be guided by the second section to the first section. This transport device is then particularly advantageous when on the pre-drying particularly a lot of moisture can be removed. Preferably, according to the invention a regulating device is provided, by means of which the exhaust air recirculating device can be controlled. A regulating device or control evaluates inputs and regulates or controls outputs by means of logic. As a rule, electrical signals of sensors of varying manner, such as for example a temperature sensor or a moisture sensor serve as inputs. As outputs serve mostly switches or electrical signals, for example for controlling the preferred heater or electrical signals, for example for controlling the preferred heater or fan.

A further method according to the invention for operating a through-flow dryer for drying a material by means of hot air with a first and a second section, through which material can be successively passed through in a transport direction and in terms of air flow are largely separated, is designed with the following steps: supplying fresh air as supply air into the second section, discharging exhaust air from the second section, supplying exhaust air as first supply air into the first section and discharging exhaust air from the first section. In this case, thermal energy of the exhaust air is transmitted to the fresh air by means of a heat exchanger.

### BRIEF DESCRIPTION OF THE DRAWINGS

An exemplary embodiment of the solution according to the invention is explained in greater detail with reference to the following drawings:

FIG. 1 shows a highly simplified longitudinal section of a through-flow dryer according to the prior art.

FIG. 2 shows a highly simplified longitudinal section of a through-flow dryer according to the invention.

FIG. 3 shows a highly simplified longitudinal section of a through-flow dryer according to the invention, which is equipped with a regulating device.

FIG. 4 shows a highly simplified longitudinal section of a through-flow dryer according to the invention, which is according to the prior art.

FIG. 5 shows a highly simplified longitudinal section of a through-flow dryer according to the invention.

FIG. 6 shows a highly simplified longitudinal section of a further through-flow dryer according to the invention, which is according to the prior art, having three regions.

FIG. 7 shows a through-flow dryer according to FIG. 6, which is equipped with a regulating device.

### DETAILED DESCRIPTION

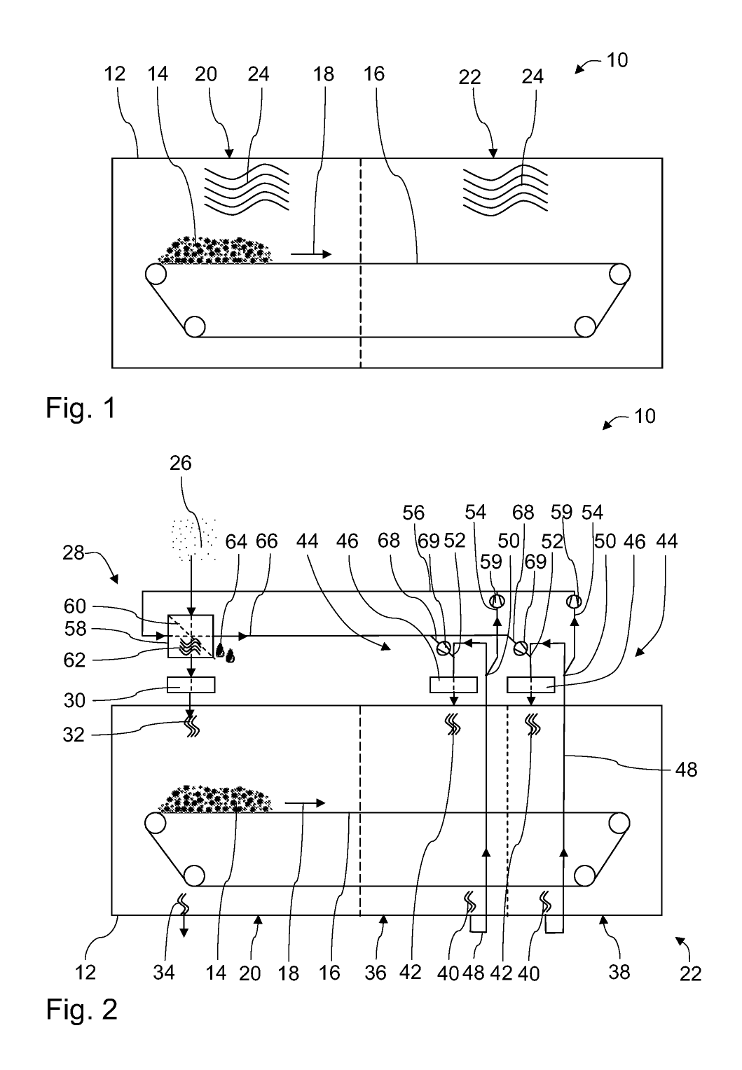

FIGS. 1 to 3 each show a through-flow dryer 10 in the form of a belt dryer. The through-flow dryer 10 has a housing 12, through which firstly moist or wet material 14 is to be transported through by means of a belt 16 in a transport direction 18. The material 14 passes through during the transporting a first section 20 and a second section 22. The two sections 20 and 22 subdivide the housing 12 spatially. Inside the housing 12 there is situated furthermore hot air 24 which removes moisture from the material 14 (not shown) to be dried. With the removal of moisture from the material 14 the material becomes dryer, it is dried.

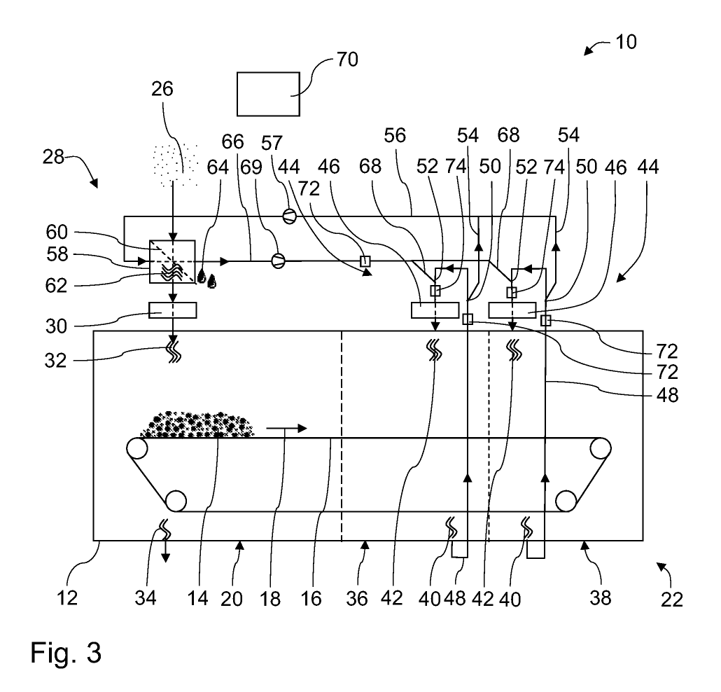

FIGS. 2 and 3 illustrate how in the exemplary embodiments there the hot air 24 is produced. For this fresh air flows from outside the housing 12, conveyed by a fresh air supply device 28, into the housing 12. The fresh air in this case flows through a first heater 30. The first heater 30 heats the fresh air 26 on its way through the heater 30. With the heating of the fresh air 26 the relative air moisture decreases, the fresh air 26 becomes “dryer”.

This fresh air 26 after heating is referred to as first supply air 32. The first supply air 32 flows into the first sector 20 and flows around there the individual particles of the material 14 or flows through the layer of the material 14 on the belt 16. On this flowing-around of the particles of the material 14 the first supply air 32 takes up moisture from the material 14. The relative air moisture of the first supply air 32 takes up moisture from the material 14. The relative air moisture of the first supply air 32 increases, the first supply air 32 becomes “dryer”. The moistened supply air 32 is subsequently removed from the first section 20 as first exhaust air 34 from the housing 12 into its surroundings. This exhaust air thus constitutes outgoing air.

After the first section 20 the material flows through the second section 22. This second section is for its part subdivided into two regions 36, 38. The two regions 36, 38 are connected in series and separated largely from one another in terms of air flow. Alternatively to the exemplary embodiments shown, the second section 22 can also be subdivided into more than two regions 36, 38, in particular three, four or five regions.

At both regions 36, 38 in each case a second exhaust air 40 is led out and in each case a second supply air 42 is supplied. The second supply air 40 is led back into the respective region by means of an exhaust air recirculation device 44 partly directly as second supply air 42 into the respective region. Before the supplying of the second supply air 42 into the respective region 36, 38, in each case a second heater 46 is provided. The second heater 46 heats the second supply air 42, whereby the relative moisture of the second supply air 42 falls.

The exhaust air recirculation device 44 comprises a recirculation line 48, through which likewise the exhaust air 40 flows. This recirculation line 48 has a branch 50 and a supply 52. At the branching 50 a part of the exhaust air is branched off and by means of a line is led into a collecting line 56. The collecting line 56, in FIG. 3, or the line 54, in FIG. 2, comprises preferably a regulated or controlled fan 57. The collecting line 56 collects the exhaust air 40 branched off from the first and second region 36, 38 and leads this exhaust air to a heat exchanger 58. The heat exchanger 58 is arranged in front of the first heater 30 in the fresh air supply device 28.

The exhaust air 40 flows through the heat exchanger 58 and at the same time the fresh air 26 flows through this heat exchanger 58. The exhaust air 40 and the fresh air 26 are thus separated from one another by means of a separating surface 60 shown symbolically in FIGS. 2 and 3. Via this separating surface 60 the exhaust air 40 and the fresh air 26 exchange heat and thermal energy. Since the exhaust air 40 is generally warmer than the fresh air 26, the fresh air is normally heated by means of the heat from the exhaust air 40. The heat of the exhaust air 40 given off is here referred to as waste heat 62. The giving off of the heat 62 has the result that the exhaust air 40 cools. How much waste heat 62 the exhaust air 40 gives off on passing through the heat exchanger 58 depends on the area and the heat permeability or the heat transition coefficient of the material.

The area and the heat permeability of the separating surface 60 are chosen in the exemplary embodiments of FIGS. 2 and 3 such that the exhaust air 40 flowing through is at the same time dehumidified. This means that at the separating surface 60 the exhaust air 40 is cooled to such an extent that there a relative air moisture of 100% (in words: one hundred per cent) prevails. At the separating surface 60 water 64 or moisture then separates out from the exhaust air 40. With the separating-out of water 64 at the separating surface 60, the water 64 is withdrawn from the exhaust air 40, the exhaust air 40 becomes dryer.

The water 64 flows off as water from the heat exchanger 58 and the dryer, cooler exhaust air 40 is led by means of a supply line 66 to the second section 22.

At the second section 22 the supply line 66 separates into two lines 68. The supply line 66, shown in FIG. 3, or the line 68, shown in FIG. 2 can advantageously comprise a fan 69. This fan 69 is in this exemplary embodiment able to be regulated with regard to its speed and act as sucking. The lines 68 connect in a flowing line the supply line 66 with the supply line 52 of the respective region 36, 38. The exhaust air 40 is thus fed into the recirculation line 48 by means of the supply line 52. Within the recirculation line 48 there forms at the supply line 52 a mixture of supplied dehumidified, colder exhaust air 40 and moist warm exhaust air 40 from the recirculation from the respective region 36, 38. This mixture of the exhaust air 40 flows through the second heater 46 as second supply air 42 into the respective regions 36, 38 of the second section 22.

In order to regulate the air flows of the exhaust air 40 and of the supply air 42 in the respective lines, the through-flow dryer 10 comprises according to FIG. 3 a regulating device 70. The regulating device 70 is operatively coupled with a plurality of exhaust air sensors 72 and to a plurality of supply-air sensors 74.

The individual exhaust air sensor 72 measures in the exhaust air 40 from the second section 22 in each case region 36, 38 the relative air moisture. Depending on the relative air moisture of the exhaust air 40 the regulating device 70 then regulates the separation of the exhaust air 40 in the region of 90 to 100% (in words: ninety to one hundred per cent), in particular 95 to 100% (in words ninety-five to one hundred per cent), exhaust air 40 is led increased to the heat exchanger 58 and the heat exchanger at the heat exchanger dehumidified.

The only supply air sensor 74 measures in the supply air 42 to the respective region 36, 38 of the second section 22 the relative air moisture in the flow direction after the supply 52 and before the second heater 46. Depending on the relative air moisture of the supply air 42, the regulating device 70 regulates the admixing of the exhaust air 40 at the supply 52.

In an alternative exemplary embodiment, not illustrated, the exhaust air sensor 72 and the supply air sensor 74 can additionally measure the temperature prevailing there.

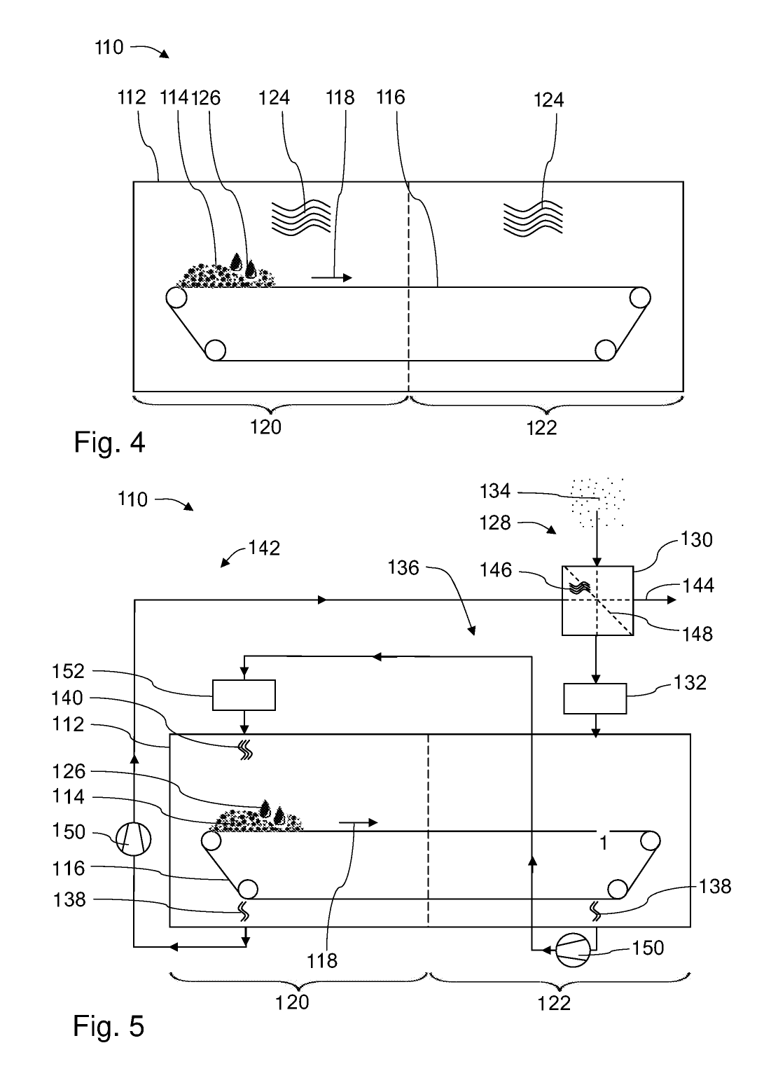

FIGS. 4 to 7 show in each case a through-flow dryer 110 in the form of a belt dryer. The through-flow dryer 110 comprises a housing 112, through which firstly moist or wet material 114 is to be transported by means of a transport belt 116 in a transporting direction 118. The material 114 passes through, on this transport, successively firstly a first section 120 and then a second section 122, which subdivide the housing 112 spatially. In each of the sections 120, 122, hot air is situated inside the housing 112. The respective hot air 124 of the individual sections 120, 122 is largely separated in terms of air flow. The hot air 124 withdraws in each of the sections the moisture 120, 122 from the material 114 or liquid 126 transported therein, in particular water. The removal of liquid 126 from the material 114 dehumidifies the material 114. The material 114 becomes dryer or is dried.

The exemplary embodiments in FIGS. 5 to 7 show the air guidance according to the invention of the hot air 124 in the sections 120 and 122. The hot air 124 for the second section 122 is generated in an air supply device 128 by means of a heat exchanger 130 and a heater 132. The heat exchanger 130 and the heater 132 in this case heat fresh air 134 from the surroundings and lead it into the second section 122. From the second section an exhaust air recirculation device 136 leads back “used” fresh air 134 as exhaust air 138 from the second section 122 into the first section 120 as supply air 140 for the first section 120. This supply air 140 is in the first section 120 further moistened by the material 114 present therein and then by means of an exhaust air recirculation device 142 is led out of the first section 120 and discharged as outgoing air 144 to the surroundings of the through-flow dryer 110.

In order that a heat energy 146 contained in the outgoing air 144 is not discharged unused into the surroundings, the exhaust air 138 is conveyed to the heat exchanger 130 of the air supply device 128 by means of the exhaust air recirculation device 142. The exhaust air 138 becomes outgoing air after flowing through the heat exchanger 144.

The heat exchanger 130 of the air supply device 128 thus at the same time has the exhaust air 38 and the fresh air 134 flowing through it. The exhaust air 138 and the fresh air 134 are in this case in terms of flow separated by means of an exchange surface 148 and separating surface. This exchange surface 148 transmits the heat energy 146 of the exhaust air 138 to the fresh air 134. In order to heat the fresh air 134 further, in the flow direction of the fresh air 134 after the heat exchanger 130 the heater is arranged, before the fresh air 134 then flows into the second section 122. In the second section 122 the fresh air 134 flows around and through the material 114 and the transport belt 116 of the transport device 118. On flowing around the material 114 the fresh air 134 takes up the liquid 126 contained in the material 114. The fresh air 134 is enriched with water or becomes more moist.

From the second section 122 the fresh air 134 flows out by means of the exhaust air recirculation device 136 as exhaust air 138. The exhaust air recirculation device 136 comprises a fan 150 and a heater 152. The fan 150 sucks the exhaust air 138 out of the second section 122 and leads it through the heater 152 into the first section 120. The heater 152 heats the exhaust air 138 in doing so. With the heating the relative air moisture of the first exhaust air 138 falls, it is thus processed or “more receptive”. The first exhaust air 138 becomes thereby supply air 140.

The supply air 140 flows through in FIG. 5 the first section 120 and in doing so takes up likewise liquid. By means of the exhaust air recirculation device 142 which comprises a fan 150, the exhaust air 138 is then discharged to the surroundings from the first section 122 after flowing through the heat exchanger 130 as outgoing air 144.

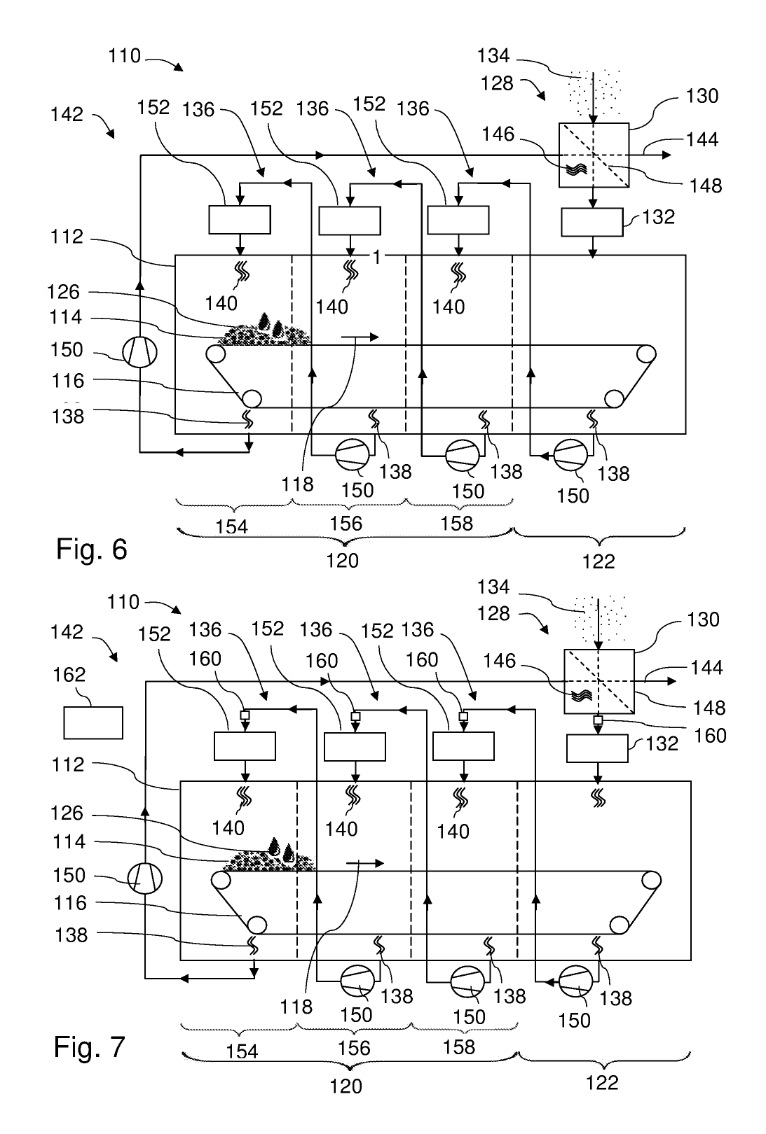

FIG. 6 and FIG. 7 show an exemplary embodiment of a through-flow dryer 110, in which the first section is subdivided into a first region 154, a second region 156 and a third region 158.

The second and third region 156, 158 are intermediate members between the second section 122 and the first region 154. The regions 154, 156, 158 form a “series circuit”. In both regions 156, 158 supply air 140 is supplied by the region following in the transport direction 118 by means of a respective recirculation device 136. The supply air 140 flows through the respective region 156, 158. After flowing through, this “used” supply air 140 is recirculated as exhaust air 138 by means of a recirculation device 136 in the transport direction 118 in the respectively preceding regions 154, 156. These exhaust air recirculation devices 136 also comprise in each case a fan 150 and a heater 152. The fan 150 transports also here the exhaust air 38 further and the heater heats this.

As shown in FIG. 7, the air supply device 128 and the exhaust air recirculation device 136 is designed with in each case one supply air sensor 160, which is provided downstream in front of the respective heaters 132 and 152. The supply air sensors 160 and the heaters 132 and 152 are operatively coupled to a regulating device 162, for example a customary programmable logic controller (PLC). In addition, the regulating device 162 is operatively coupled to the heaters 132, 152 and additionally or alternatively to the fans 150. The regulating device 162 regulates thus, by means of which signals determined by the supply air sensors 160 the respective heaters 132 and 152. Depending on the embodiment of the regulating device 162, additionally or alternatively the respective fans 150 are regulated.

### LIST OF REFERENCE SYMBOLS

10 through-flow dryer
12 housing
14 material
16 belt
18 transport direction
20 section
22 section
24 hot air
26 fresh air
28 fresh-air supply device
30 heater
32 supply air
34 exhaust air
36 region
38 region
40 exhaust air
42 supply air
44 exhaust air recirculation device
46 heater
48 recirculation device
50 branch
52 supply
54 line
56 collecting line
57 fan
58 heat exchanger
60 separating surface
62 waste heat
64 water
66 supply line
68 line
69 fan
70 regulating device
72 exhaust air sensor
74 supply air sensor
110 through-flow dryer
112 housing
114 material
116 transport belt
118 transport direction
120 first section
122 second section
124 hot air
126 liquid
128 air supply device
130 heat exchanger
132 heater
134 fresh air
136 exhaust air recirculation device
138 exhaust air
140 supply air
142 exhaust air recirculation device
144 outgoing air
146 thermal energy
148 exchange surface
150 fan
152 heater
154 region
156 region
158 region
160 supply air sensor
162 regulating device

1-10. (canceled)

11. A continuous flow dryer for drying a material by means of hot air, comprising:
a first section and a second section through which the material passes successively in a transport direction, the first section and the second section being largely separated in terms of air flow;
a fresh air supply device for supplying fresh air as first supply air into the first section;
an exhaust air recirculating device for discharging exhaust air from the second section and for recirculating exhaust air as second supply air back into the second section; and
a heat exchanger through which the fresh air and the exhaust air are led, the heat exchanger being configured to conduct waste heat from the exhaust air into the fresh air.

12. The continuous flow dryer according to claim 11, wherein the heat exchanger is dimensioned such that water condenses out on it from the exhaust air.

13. The continuous flow dryer according to claim 11, further comprising a first heater for heating the first supply air before it is supplied into the first section.

14. The continuous flow dryer according to claim 11, further comprising a second heater for heating the second supply air before it is recirculated into the second section.

15. The continuous flow dryer according to claim 11, wherein the exhaust air recirculating device is provided with a recirculating line, for direct recirculating of exhaust air from the second section as recirculating air back into the second section.

16. The continuous flow dryer according to claim 11,
wherein at least two regions are provided in the second section and
wherein the exhaust air of the two regions is guided together through the heat exchanger.

17. The continuous flow dryer according to claim 11, further comprising an exhaust air sensor by means of which a moisture in the exhaust air can be determined.

18. The continuous flow dryer according to claim 11, wherein two belts are provided for transporting the material through the continuous flow dryer.

19. The continuous flow dryer according to claim 18, wherein the two belts include a first belt assigned to the first section and a second belt assigned to the second section.

20. The continuous flow dryer according claim 11, wherein the transport direction is directed from the second section to the first section.

21. A method for operating a through-flow dryer for drying a material by means of hot air, the through-flow dryer having a first section and a second section through which the material passes successively in a transporting direction, the first section and the second section being largely separated in terms of air flow, comprising:
supplying fresh air as first supply air into the first section;
discharging exhaust air from the second section;
recirculating exhaust air as second supply air back into the second section; and
conducting exhaust heat from the exhaust air into the fresh air.
